(19) United States
(12) Patent Application Publication
(10) Pub. No.: US 2025/0071587 A1
(43) Pub. Date: Feb. 27, 2025

(54) METHOD AND APPARATUS FOR MEASUREMENT OPERATION IN COMMUNICATION SYSTEM

(71) Applicant: ELECTRONICS AND TELECOMMUNICATIONS RESEARCH INSTITUTE, Daejeon (KR)

(72) Inventors: Jung Bin KIM, Daejeon (KR); Pan Soo KIM, Daejeon (KR); Joon Gyu RYU, Daejeon (KR); Gyeong Rae IM, Daejeon (KR)

(73) Assignee: ELECTRONICS AND TELECOMMUNICATIONS RESEARCH INSTITUTE, Daejeon (KR)

(21) Appl. No.: 18/722,336

(22) PCT Filed: Dec. 13, 2022
(86) PCT No.: PCT/KR2022/020251

§ 371 Date: Jun. 20, 2024

(30) Foreign Application Priority Data
Dec. 21, 2021 (KR) 10-2021-0184233

(51) Int. Cl. H04W 24/10; H04L 27/26; H04W 72/0446

(52) U.S. Cl. CPC H04W 24/10; H04L 27/26025; H04W 72/0446

(57) ABSTRACT

Disclosed are a method and apparatus for a measurement operation in a communication system. The method for a terminal comprises the steps of: receiving measurement configuration information from a base station; identifying a point in time of start of a measurement gap on the basis of the measurement configuration information; identifying the length of the measurement gap on the basis of the measurement configuration information; and performing a measurement operation in the measurement gap, wherein the measurement gap is configured in units of slots, the point in time of start of the measurement gap is a start slot, and the measurement gap includes one or more slots.

### TECHNICAL FIELD

The present disclosure relates to a measurement technique in a communication system, and more particularly, to a technique for configuring a measurement gap in which a measurement operation is performed.

### BACKGROUND ART

To process rapidly increasing radio data, a communication network (e.g., new radio (NR) communication network) using a frequency band (e.g., a frequency band of 6 GHz or above) higher than a frequency band (e.g., a frequency band of 6 GHz or below) of a long term evolution (LTE) (or LTE-A) is being considered. The NR communication network can support a frequency band of 6 GHz or above as well as a frequency band of 6 GHz or below, and can support various communication services and scenarios compared to the LTE communication network. For example, usage scenarios of the NR communication network may include enhanced mobile broadband (eMBB), ultra-reliable low-latency communication (URLLC), massive machine type communication (mMTC), and the like.

The NR communication network may provide communication services to terminals located on terrestrial sites. Recently, demand for communication services for airplanes, drones, satellites, etc. located not only on the terrestrial sites but also on the non-terrestrial space is increasing, and for this purpose, technologies for a non-terrestrial network (NTN) are being discussed. The NTN can be implemented based on the NR technology. For example, in the NTN, communication between a satellite and a communication node located on a terrestrial site or between communication n nodes (e.g., airplanes, drones, etc.) located in non-terrestrial locations may be performed based on the NR technology. In the NTN, a satellite may perform functions of a base station in the NR communication network.

Meanwhile, in the communication network, the terminal may perform a measurement operation, and the measurement operation may be performed within a measurement gap configured by the base station. The non-terrestrial network may provide a communication service in an FR2 band, and a frame structure (e.g., the number of symbols included in a frame) may vary according to a subcarrier spacing (SCS). In the above situation, methods for configuring the measurement gap to efficiently perform the measurement operation are required.

### DISCLOSURE

### Technical Problem

The present disclosure is directed to providing a method and an apparatus for configuring a measurement gap in which a measurement operation is performed in a communication system.

### Technical Solution

An operation method of a terminal, according to a first exemplary embodiment of the present disclosure for achieving the above-described objective, may comprise: receiving measurement configuration information from a base station; identifying a start time of a measurement gap based on the measurement configuration information; identifying a length of the measurement gap based on the measurement configuration information; and performing a measurement operation in the measurement gap, wherein the measurement gap is configured in units of slots, the start time of the measurement gap is a start slot, and the measurement gap includes one or more slots.

The identifying of the start time of the measurement gap may comprise: identifying the start slot based on a first information element indicating the start slot of the measurement gap, the first information element being included in the measurement configuration information.

The identifying of the start time of the measurement gap may comprise: identifying a start subframe based on a second information element indicating the start subframe of the measurement gap, the second information element being included in the measurement configuration information; and identifying the start slot within the start subframe based on a first information element indicating the start slot of the measurement gap, the first information element being included in the measurement configuration information.

The start slot of the measurement gap may be identified based on an equation z=(yₛₗₒₜ mod 2^{μ}), wherein z indicates the start slot, yₛₗₒₜ is a value determined based on a second information element indicating a start subframe of the measurement gap, and μ indicates a numerology, the second information element being included in the measurement configuration information.

The start slot of the measurement gap may be identified based on an equation z=(yₛₗₒₜ mod r×2^{μ}), wherein z indicates the start slot, yₛₗₒₜ is a value determined based on a second information element indicating a start subframe of the measurement gap, r is a value determined based on a third information element indicating a number of subframes for which slot numbers are consecutively configured, and μ indicates a numerology, the second and third information elements being included in the measurement configuration information.

The length of the measurement gap may be identified based on an equation L=(t_{RF}×2+tₛₗₒₜ×n), wherein L indicates the length of the measurement gap, t_{RF} is a value determined based on a fourth information element indicating a radio frequency (RF) retuning time, tₛₗₒₜ indicates a time of one slot, and n is a value determined based on a fifth information element indicating a number of slots determining the length of the measurement gap, the fourth and fifth information elements being included in the measurement configuration information.

The measurement configuration information may include a sixth information element indicating a time when the measurement gap is configured in a non-terrestrial network, the sixth information element may be a time offset, and the measurement gap may be configured after the time offset from a time when the measurement configuration information is received.

The measurement configuration information may include a seventh information element indicating a network to which the measurement configuration information is applied, and the seventh information element may indicate that the measurement configuration information is applied to at least one of a terrestrial network and a non-terrestrial network.

An operation method of a base station, according to a second exemplary embodiment of the present disclosure for achieving the above-described objective, may comprise: generating measurement configuration information for configuring a measurement gap based on slot(s); transmitting the measurement configuration information to a terminal; and transmitting a synchronization signal block (SSB) to the terminal in the measurement gap configured based on the measurement configuration information, wherein the measurement gap includes one or more slots, and the measurement configuration information includes a first information element indicating a start slot of the measurement gap.

The measurement configuration information may further include a second information element indicating a start subframe of the measurement gap, and the start slot may be located within the start subframe indicated by the second information element.

The length of the measurement gap may be identified based on an equation L=(t_{RF}×2+tₛₗₒₜ×n), wherein L indicates the length of the measurement gap, t_{RF} is a value determined based on a third information element indicating a radio frequency (RF) retuning time, tₛₗₒₜ indicates a time of one slot, and n is a value determined based on a fourth information element indicating a number of slots determining the length of the measurement gap, the third and fourth information elements being included in the measurement configuration information.

The measurement configuration information may include a fifth information element indicating a time when the measurement gap is configured in a non-terrestrial network, the fifth information element may be a time offset, and the measurement gap may be configured after the time offset from a time when the measurement configuration information is transmitted.

The measurement configuration information may include a sixth information element indicating a network to which the measurement configuration information is applied, and the sixth information element may indicate that the measurement configuration information is applied to at least one of a terrestrial network and a non-terrestrial network.

A terminal, according to a third exemplary embodiment of the present disclosure for achieving the above-described objective, may comprise a processor, wherein the processor may be executed to cause the terminal to: receive measurement configuration information from a base station; identify a start time of a measurement gap based on the measurement configuration information; identify a length of the measurement gap based on the measurement configuration information; and perform a measurement operation in the measurement gap, wherein the measurement gap is configured in units of slots, the start time of the measurement gap is a start slot, and the measurement gap includes one or more slots.

In the identifying of the start time of the measurement gap, the processor may be executed to cause the terminal to: identify the start slot based on a first information element indicating the start slot of the measurement gap, the first information element being included in the measurement configuration information.

In the identifying of the start time of the measurement gap, the processor may be executed to cause the terminal to: identify a start subframe based on a second information element indicating the start subframe of the measurement gap, the second information element being included in the measurement configuration information; and identify the start slot in the start subframe based on a first information element indicating the start slot of the measurement gap, the first information element being included in the measurement configuration information.

The start slot of the measurement gap may be identified based on an equation z=(yₛₗₒₜ mod 2^{μ}), wherein z indicates the start slot, yₛₗₒₜ is a value determined based on a second information element indicating a start subframe of the measurement gap, and μ indicates a numerology, the second information element being included in the measurement configuration information.

The start slot of the measurement gap may be identified based on an equation z=(yₛₗₒₜ mod r×2^{μ}), wherein z indicates the start slot, yₛₗₒₜ is a value determined based on a second information element indicating a start subframe of the measurement gap, r is a value determined based on a third information element indicating a number of subframes for which slot numbers are consecutively configured, and μ indicates a numerology, the second and third information elements being included in the measurement configuration information.

The length of the measurement gap may be identified based on an equation L=(t_{RF}×2+tₛₗₒₜ×n), wherein L indicates the length of the measurement gap, t_{RF} is a value determined based on a fourth information element indicating a radio frequency (RF) retuning time, tₛₗₒₜ indicates a time of one slot, and n is a value determined based on a fifth information element indicating a number of slots determining the length of the measurement gap, the fourth and fifth information elements being included in the measurement configuration information.

The measurement configuration information may include at least one of a sixth information element indicating a time when the measurement gap is configured in a non-terrestrial network or a seventh information element indicating a network to which the measurement configuration information is applied, the sixth information element may be a time offset, the measurement gap may be configured after the time offset from a time when the measurement configuration information is received, and the seventh information element may indicate that the measurement configuration information is applied to at least one of a terrestrial network and a non-terrestrial network.

### Advantageous Effects

According to the present disclosure, a measurement gap may be configured in units of slots. Therefore, the length of the measurement gap may be minimized, and resource wastes due to the configuration of the measurement gap may be reduced. Accordingly, a transmission rate of data can be improved, which can lead to improved performance of the communication system.

### DESCRIPTION OF DRAWINGS

FIG. 1 is a conceptual diagram illustrating a first exemplary embodiment of a non-terrestrial network.

FIG. 2 is a conceptual diagram illustrating a second exemplary embodiment of a non-terrestrial network.

FIG. 3 is a block diagram illustrating a first exemplary embodiment of an entity constituting a non-terrestrial network.

FIG. 4 is a conceptual diagram illustrating a first exemplary embodiment of a measurement gap.

FIG. 5 is a conceptual diagram illustrating a second exemplary embodiment of a measurement gap.

FIG. 6 is a conceptual diagram illustrating a first exemplary embodiment of an SSB transmission method.

FIG. 7 is a conceptual diagram illustrating a first exemplary embodiment of a frame structure.

FIG. 8 is a conceptual diagram illustrating a first exemplary embodiment of a communication system.

FIG. 9 is a conceptual diagram illustrating a first exemplary embodiment of multiple beams formed by a satellite.

FIG. 10 is a conceptual diagram illustrating a first exemplary embodiment of a slot-based measurement gap.

FIG. 11 is a sequence chart illustrating a first exemplary embodiment of a measurement operation in a communication system.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/of” means any one or a combination of a plurality of related and described items.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

A communication network to which exemplary embodiments according to the present disclosure are applied will be described. The communication system may include a non-terrestrial network (NTN), a 4G communication network (e.g., long-term evolution (LTE) communication network), and/or a 5G communication network (e.g., new radio (NR) communication network). The 4G communication network or 5G communication network may be classified as terrestrial networks.

The NTN may operate based on the LTE technology and/or the NR technology. The NTN may support communications in frequency bands below 6 GHz as well as in frequency bands above 6 GHz. The 4G communication network may support communications in the frequency band below 6 GHz. The 5G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks. Here, the communication network may be used in the same sense as the communication system.

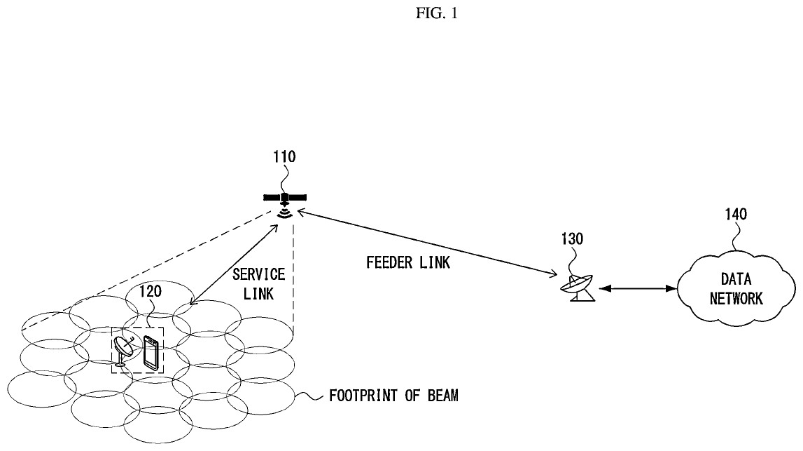

FIG. 1 is a conceptual diagram illustrating a first exemplary embodiment of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS).

The communication node 120 may include a communication node (e.g., a user equipment (UE) or a terminal) located on a terrestrial site and a communication node (e.g., an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g., downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g., base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g., AMF, UPF, SMF, and the like) may be performed based on an NG-C/U interface.

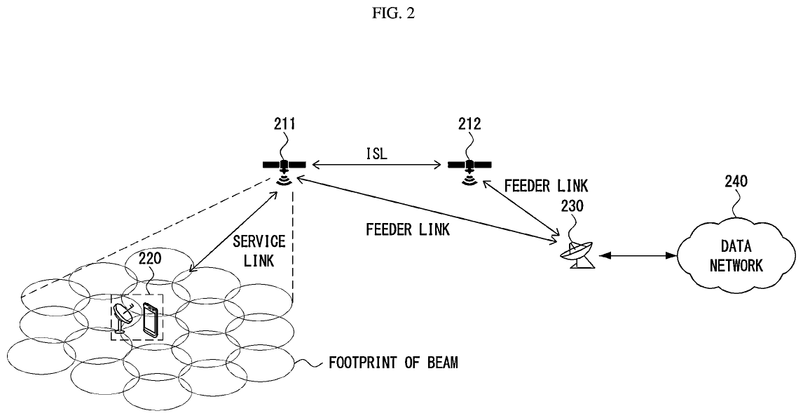

FIG. 2 is a conceptual diagram illustrating a second exemplary embodiment of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g., demodulation, decoding, re-encoding, re-modulation, and/or filtering operation) on a payload received from other entities (e.g., the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g., UE or terminal) and a non-terrestrial communication node (e.g., airplane or drone). A service link (e.g., radio link) may be established between the satellite 211 and communication node 220. The satellite 211 may provide communication services to the communication node 220 using one or more beams.

The communication node 220 may perform communications (e.g., downlink communication or uplink communication) with the satellite 211 using LTE technology and/or NR technology. The communications between the satellite 211 and the communication node 220 may be performed using an NR-Uu interface. When DC is supported, the communication node 220 may be connected to other base stations (e.g., base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g., AMF, UPF, SMF, and the like) may be performed based on an NG-C/U interface.

Meanwhile, entities (e.g., satellites, communication nodes, gateways, etc.) constituting the NTNs shown in FIGS. 1 and 2 may be configured as follows.

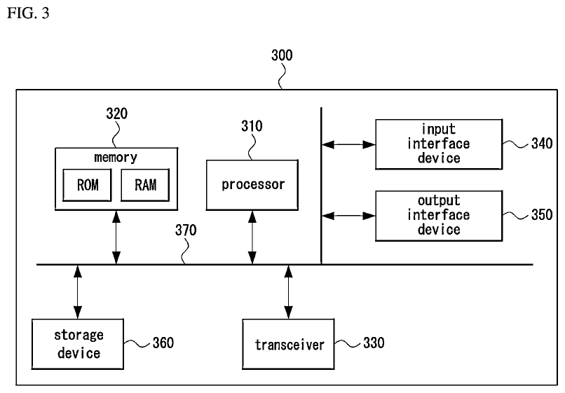

FIG. 3 is a block diagram illustrating a first exemplary embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, scenarios in the NTN may be defined as shown in Table 1 below.

TABLE 1

| | NTN shown in FIG. 1 | NTN shown in FIG. 2 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g., a GEO satellite that supports a transparent function), this may be referred to as ‘scenario A’. When the satellites 211 and 212 in the NTN shown in FIG. 2 are GEO satellites (e.g., GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D2’.

TABLE 2

| | Scenarios A and B | Scenarios C and D |
|---|---|---|
| Altitude | 35,786 km | 600 km |
| | | 1,200 km |
| Spectrum | <6 GHz (e.g., 2 GHz) | |
| (service link) | >6 GHz (e.g., DL 20 GHz, UL 30 GHz) | |
| Maximum channel | 30 MHz for band <6 GHz | |
| bandwidth capability | 1 GHz for band >6 GHz | |
| (service link) | | |
| Maximum distance | 40,581 km | 1,932 km (altitude |
| between satellite and | | of 600 km) |
| communication node (e.g., | | 3,131 km (altitude |
| UE) at the minimum | | of 1,200 km) |
| elevation angle | | |
| Maximum round trip | Scenario A: 541.46 ms | Scenario C: (transparent |
| delay (RTD) | (service and feeder links) | payload: service and |
| (only propagation delay) | Scenario B: 270.73 ms | feeder links) |
| | (only service link) | −5.77 ms (altitude |
| | | of 600 km) |
| | | −41.77 ms (altitude |
| | | of 1,200 km) |
| | | Scenario D: (regenerative |
| | | payload: only service link) |
| | | −12.89 ms (altitude |
| | | of 600 km) |
| | | −20.89 ms (altitude |
| | | of 1,200 km) |
| Maximum delay variation | 16 ms | 4.44 ms (altitude |
| within a single beam | | of 600 km) |
| | | 6.44 ms (altitude |
| | | of 1,200 km) |
| Maximum differential | 10.3 ms | 3.12 ms (altitude |
| delay within a cell | | of 600 km) |
| | | 3.18 ms (altitude |
| | | of 1,200 km) |

| | |
|---|---|
| Service link | NR defined in 3GPP |
| Feeder link | Radio interfaces defined in |
| | 3GPP or non-3GPP |

In addition, in the scenarios defined in Table 1, delay constraints may be defined as shown in Table 3 below.

TABLE 3

| | Scenario | Scenario | Scenario | Scenario |
|---|---|---|---|---|
| | A | B | C1-2 | D1-2 |
| Satellite altitude | 35,786 km | | 600 km | |
| Maximum RTD in | 541.75 ms | 270.57 ms | 28.41 ms | 12.88 ms |
| a radio interface | (worst case) | | | |
| between base | | | | |
| station and UE | | | | |
| Minimum RTD in | 477.14 ms | 238.57 ms | 8 ms | 4 ms |
| a radio interface | | | | |
| between base | | | | |
| station and UE | | | | |

Hereinafter, communication methods in a communication system will be described. Even when a method (e.g., transmission or reception of a signal) performed at a first communication node among communication nodes is described, the corresponding second communication node may perform a method (e.g., reception or transmission of the signal) corresponding to the method performed at the first communication node. That is, when an operation of the terminal is described, the corresponding base station may perform an operation corresponding to the operation of the terminal. Conversely, when an operation of the base station is described, the corresponding terminal may perform an operation corresponding to the operation of the base station.

Meanwhile, in order to provide a reliable communication connection and/or high transmission rate to a terminal, a handover operation supporting access to a neighboring cell in a communication system (e.g., communication network), multi-connectivity supporting connections to different networks, a frequency band switching operation supporting switching to another frequency band (e.g., intra-frequency band, inter-frequency band), and the like may be supported. The multi-connectivity may be referred to as dual connectivity (DC).

To support the above-described operations, the terminal may perform measurement operations. The measurement operation may be performed on neighboring cells, neighboring base stations, other networks, other systems, and/or other frequency bands. The terminal may measure a strength and/or quality of a received signal by performing the measurement operation. The measurement operation may be performed within a measurement gap. The base station may configure a measurement gap and transmit measurement gap configuration information (e.g., measurement gap pattern) to the terminal. That is, the base station may transmit the measurement gap configuration information to the terminal in order to support the measurement operation of the terminal.

The measurement gap configuration information may be MeasGapConfig, MeasGapConfig may be included in MeasConfig, and MeasConfig may be included in a higher layer message (e.g., radio resource control (RRC) message) transmitted from the base station to the terminal. The terminal may receive the measurement gap configuration information from the base station, and perform a measurement operation within the measurement gap indicated by the configuration information. The terminal may not be able to perform a data reception operation in the measurement gap. Accordingly, the base station may not transmit data to the terminal in the measurement gap. The measurement gap configuration information (MeasGapConfig) may include one or more information elements defined in Table 4 below.

TABLE 4

| | Description |
|---|---|
| mgl | Measurement gap length (mgl) may refer to a time period of the |
| | measurement gap. mgl may be set to one value among 1 ms, 1.5 ms, |
| | 2 ms, 3 ms, 3.5 ms, 4 ms, 5 ms, 5.5 ms, 6 ms, 10 ms, or 20 ms. |
| mgrp | Measurement gap repetition periodicity (mgrp) may refer to a |
| | periodicity of the measurement gap. mgrp may be set to 20 ms, 40 ms, |
| | 80 ms, or 160 ms. |
| RF retuning | Radio frequency (RF) retuning time may refer to a time period for RF |
| time (e.g., | retuning of the terminal. The RF retuning time may be 0.5 ms in a |
| mgta) | frequency range 1 (FR1) including sub-6GH frequency bands. The |
| | RF retuning time may be 0.25 ms in an FR2 including 24-100 GHz |
| | frequency bands |
| gapOffset | gapOffset may refer to an offset of the measurement gap (e.g., |
| | measurement gap pattern). gapOffset may indicate a start subframe |
| | of the measurement gap within a period of the measurement gap. |
| | gapOffset may be set to one value among 0 to mgrp-1. mgrp-1 may |
| | be 159 ms. |

The base station may transmit the measurement gap configuration information to the terminal using RRC signaling. The terminal may obtain the measurement gap configuration information through RRC signaling. The terminal may perform measurement operations on neighboring cells, neighboring base stations, other networks, other systems, and/or other frequency bands within the measurement gap indicated by the configuration information. In the measurement operation, the terminal may receive a signal, and measure a strength and/or quality of the received signal. The signal that is a target of the measurement operation may be a reference signal and/or a synchronization signal. The synchronization signal may be a synchronization signal block (SSB). The SSB may be referred to as a synchronization signal/physical broadcast channel (SS/PBCH) block.

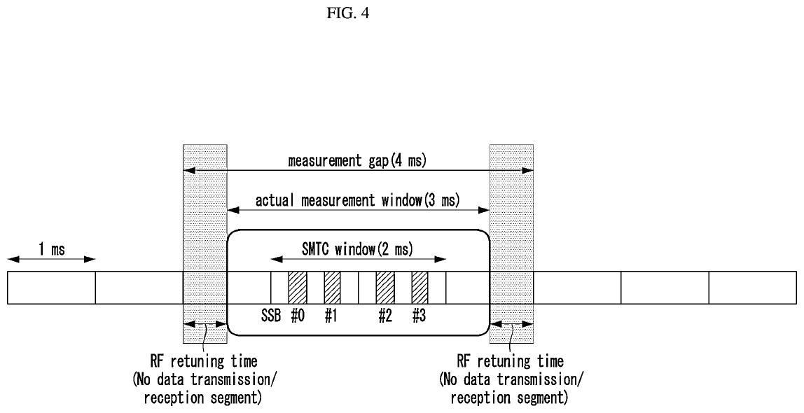

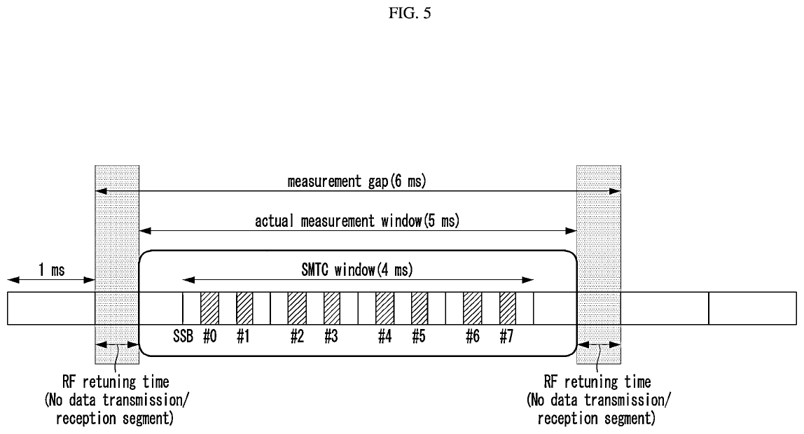

FIG. 4 is a conceptual diagram illustrating a first exemplary embodiment of a measurement gap, and FIG. 5 is a conceptual diagram illustrating a second exemplary embodiment of a measurement gap.

Referring to FIGS. 4 and 5, the base station may configure an SSB measurement timing configuration (SMTC) window in the terminal, and the terminal may identify the SMTC window configured by the base station. The SMTC window may mean a measurement period of SSB(s). The terminal may perform a measurement operation on SSB(s) in the SMTC window within the measurement gap. In the exemplary embodiment of FIG. 4, the subcarrier spacing (SCS) may be 15 kHz, the RF retuning time may be 0.5 ms, the length of the measurement gap may be 4 ms, the length of an actual measurement window may be 3 ms, and the length of the SMTC window may be 2 ms. In the exemplary embodiment of FIG. 5, the SCS may be 15 kHz, the RF retuning time may be 0.5 ms, the length of the measurement gap may be 6 ms, the length of an actual measurement window may be 5 ms, and the length of the SMTC window may be 4 ms.

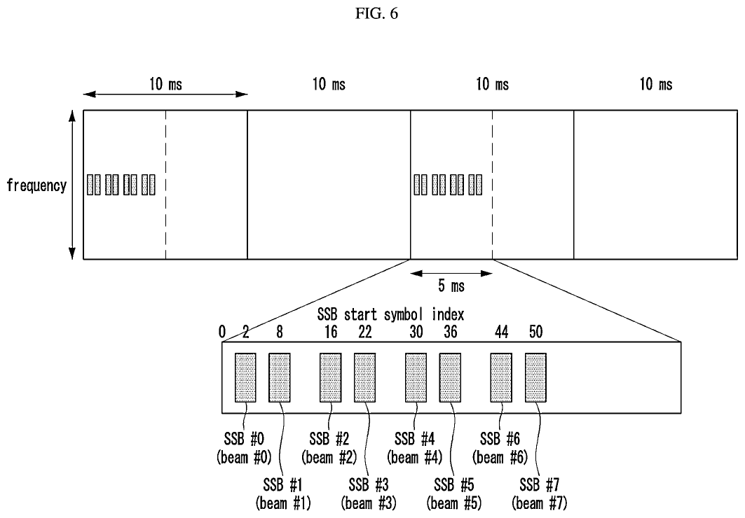

FIG. 6 is a conceptual diagram illustrating a first exemplary embodiment of an SSB transmission method.

Referring to FIG. 6, the base station may periodically transmit SSB(s). That is, SSB(s) receivable by the terminal may be transmitted periodically within the measurement gap. The exemplary embodiment of FIG. 6 may show SSB transmission times when the SCS is 15 kHz in a sub-6 GHz band. The base station may transmit 8 SSBs using different beams in a period of 5 ms. 8 SSBs transmitted in a period of 5 ms may be referred to as an SSB burst set. A periodicity of the SSB burst set may be 20 ms. One SSB may be transmitted using 4 symbols in the time domain. The communication system may support numerologies defined in Table 5 below.

TABLE 5

| | Numerology (μ) | | | | | |
|---|---|---|---|---|---|---|
| | 0 | 1 | 2 | 3 | 4 | 5 |
| Subcarrier | 15 kHz | 30 kHz | 60 kHz | 120 kHz | 240 kHz | 480 kHz |
| spacing | | | | | | |
| OFDM symbol | 66.7 | 33.3 | 16.7 | 8.3 | 4.2 | 2.1 |
| length (μs) | | | | | | |
| CP length (μs) | 4.76 | 2.38 | 1.19 | 0.60 | 0.30 | 0.15 |
| Number of | 14 | 28 | 56 | 112 | 224 | 448 |
| OFDM symbols | | | | | | |
| within 1 ms | | | | | | |

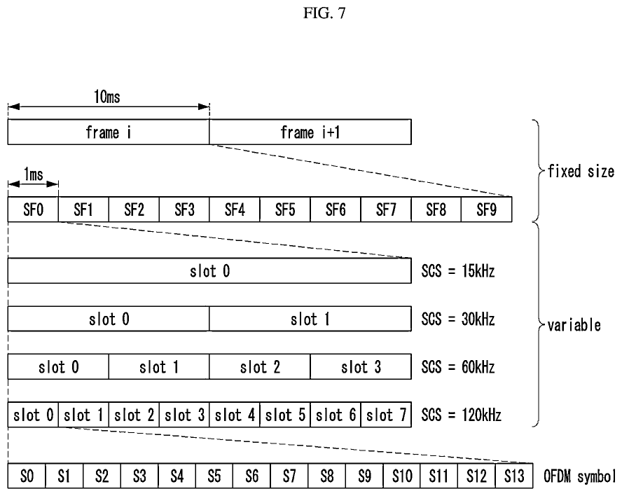

FIG. 7 is a conceptual diagram illustrating a first exemplary embodiment of a frame structure.

Referring to FIG. 7, the length of a subframe may be 1 ms, and the number of slots (or the number of symbols) included in the subframe may vary according to SCS. A subframe may be referred to as SF, and S0 may mean the first subframe within a frame. A symbol may be referred to as S, and S0 may mean the first symbol within a slot. The symbol may mean an orthogonal frequency division multiplexing (OFDM) symbol. When the SCS is 15 kHz, a subframe may include one slot (i.e., 14 symbols). When the SCS is 120 kHz, a subframe may include 8 slots (i.e., 112 symbols). Since the number of symbols included in one subframe increases as the SCS increases, the number of transmittable SSBs may also increase.

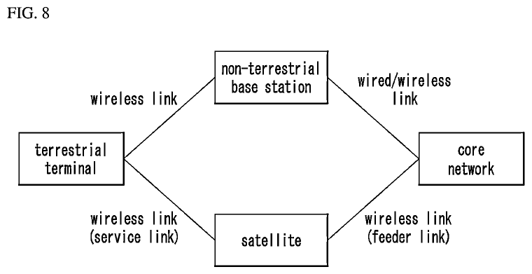

FIG. 8 is a conceptual diagram illustrating a first exemplary embodiment of a communication system.

Referring to FIG. 8, a communication system may include a terrestrial network and a non-terrestrial network. The terrestrial network may include a terrestrial terminal, a terrestrial base station, and a core network. The non-terrestrial network may include the terrestrial terminal, a satellite, and the core network. The non-terrestrial network may further include a gateway. In a transparent payload based non-terrestrial network, a base station (e.g., non-terrestrial base station) may be located between the gateway and the core network. In a regenerative payload based non-terrestrial network, a base station (e.g., non-terrestrial base station) may be located in the satellite. In the present disclosure, a terminal may be interpreted as a terrestrial terminal or a non-terrestrial terminal depending on context, and a base station may be interpreted as a terrestrial base station or a non-terrestrial base station depending on context.

In order to provide reliable communication connection and high-speed transmission services to a terminal, the communication system may support multi-connectivity (e.g., dual connectivity (DC)) between a terrestrial base station and a satellite. When multiple beams are used in the non-terrestrial network (e.g., the satellite uses multiple beams), each beam may be spatially assigned to a different region.

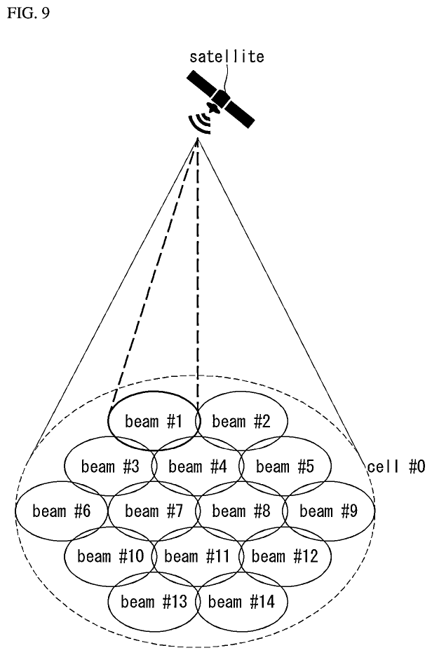

FIG. 9 is a conceptual diagram illustrating a first exemplary embodiment of multiple beams formed by a satellite.

Referring to FIG. 9, a satellite may provide a communication service using multiple beams in one cell (e.g., cell #0). Each of the multiple beams may cover a different region. The multiple beams may include spatially separated beams #1 to #14, and each of the beams #1 to #14 may provide a communication service to a different region. Each of the beam #1 to beam #14 may be a narrow beam. The different beams may be respectively mapped to SSBs belonging to an SSB burst set. The terminal may receive an SSB for a beam corresponding to a region in which it is located. When the terminal is located in a region covered by the beam #2, the terminal may receive an SSB #2 corresponding to the beam #2 (e.g., the SSB #2 mapped to the beam #2). In the exemplary embodiment of FIG. 9, different cell IDs may be assigned to the beams #1 to #14, and the beams having different cell IDs may be operated.

In the communication system supporting multi-connectivity, the terminal may access a communication node (i.e., terrestrial base station or satellite) providing a superior communication quality among the terrestrial base station and the satellite. For example, a terminal connected to the terrestrial base station may perform a measurement operation on the satellite within a measurement gap, and based on a result of the measurement operation, the terminal may maintain the connection with the terrestrial base station when the terrestrial base station has a superior communication quality, or may access the satellite instead of the terrestrial base station when the satellite has a superior communication quality. Alternatively, a terminal connected to the satellite may perform a measurement operation on the terrestrial base station within the measurement gap, and based on a result of the measurement operation, the terminal may maintain the connection with the satellite when the satellite has a superior communication quality, or may access the terrestrial base station instead of the satellite when the terrestrial base station has a superior communication quality. The result of the measurement operation may be a received signal strength of SSB(s).

In the measurement gap, the terminal may not be able to perform a data reception operation. When the measurement gap is frequently configured and/or when the measurement operation is frequently performed in the measurement gap, data transmission performance may be degraded. Accordingly, methods to reduce the measurement gap may be required. Even in scenarios below, the length of the measurement gap may be set long, and in this case, communication efficiency may be degraded.

(Scenario 1) When communication is performed in an FR2 band, an available frequency bandwidth may increase, and an SCS of 240 kHz or higher may be used. In this case, the number of slots and symbols included in a subframe may increase. In the above situation, the length of the measurement gap may be set short.

(Scenario 2) When multiple beams are used in the non-terrestrial network, the terminal may receive a specific SSB (e.g., SSB associated with a beam covering a region where the terminal is located) instead of all SSBs. Accordingly, the measurement gap may be specified as a reception period of the specific SSB. In the above situation, the length of the measurement gap may be set short.

A start time of the conventional measurement gap may be indicated in units of subframes. Therefore, in Scenario 1 and/or Scenario 2, there may be many symbols in which SSB(s) are not transmitted within the measurement gap. In this case, resources may be wasted. Measurement gap configuration methods for minimizing the length of the measurement gap and reducing resource wastes may be required.

### [Measurement Gap Start Time Configuration Method 1]

A measurement gap may be configured in units of slots. The measurement gap may include one or more slots. Based on Equation 1 below, the number of slots included in a subframe may be 2^{μ}. μ may indicate a numerology and may be set to an integer (e.g., 0, 1, 2, 3, . . . ). Numbers (e.g., indexes) of consecutive slots within one subframe may be 0 to 2^{μ}−1. For example, when the SCS is 240 kHz, μ may be 4, 16 slots may be included in one subframe, and numbers (indexes) of the 16 slots may be 0 to 15. Alternatively, the numbers of slots in consecutive subframes may be configured consecutively.

$$SCS = {2}^{μ} \times 15 [ kHz ] \qquad [ Equation 1 ]$$

The SSBs corresponding to the respective beams may be transmitted through different symbols in the time domain. Accordingly, the base station may additionally deliver a start number (e.g., start time) of one or more slots through which the SSB(s) are transmitted to the terminal. For example, the base station may transmit information on a start slot number of the measurement gap to the terminal. The information on the start slot number of the measurement gap may be transmitted together with one or more information elements defined in Table 4.

The measurement gap may be configured to include all SSBs (e.g., all SSBs associated with all beams) or specific SSBs (e.g., specific SSBs associated with specific beams). The SSB may correspond to each beam. Alternatively, the SSB may correspond to polarization.

The information indicating the start slot number of the measurement gap may be referred to as yₛₗₒₜ. yₛₗₒₜ may be set to one of 0 to 2^{μ}−1. Considering a limitation in the size of a new field for signaling yₛₗₒₜ, a value of yₛₗₒₜ may be limited to some value(s) from 0 to 2^{μ}−1. The measurement gap configuration information (e.g., MeasGapConfig or MeasConfig) may further include yₛₗₒₜ. The base station (e.g., terrestrial base station or non-terrestrial base station) may transmit the measurement gap configuration information to the terminal using RRC signaling.

The terminal may receive the measurement gap configuration information from the base station through RRC signaling, and may identify one or more information elements (e.g., mgl, mgrp, RF retuning time, gapOffset, and/or yₛₗₒₜ) included in the measurement gap configuration information. mgl, mgrp, RF retuning time, and gapOffset may be the information elements defined in Table 4. The terminal may identify a start slot of the measurement gap based on yₛₗₒₜ without considering gapOffset. Alternatively, the terminal may identify a start subframe of the measurement gap based on gapOffset, and identify a start slot within the start subframe based on yₛₗₒₜ. The terminal may perform a measurement operation (e.g., SSB measurement operation) from the identified start slot.

In addition, the base station may transmit information indicating a configuration unit (e.g., subframe or slot) of the measurement gap to the terminal. The information indicating a measurement gap configuration unit may be included in the measurement gap configuration information (e.g., MeasConfig or MeasGapConfig). The terminal may identify the measurement gap configuration unit based on the information received from the base station, and interpret the information element(s) included in the configuration information (e.g., measurement configuration information) of the measurement gap based on the configuration unit.

### [Measurement Gap Start Time Configuration Method 2]

In order to indicate the start slot number of the measurement gap, the existing field(s) included in the measurement gap configuration information may be reused. That is, a new field for notifying the start slot number of the measurement gap may not be added to the measurement gap configuration information. For example, gapOffset included in the measurement gap configuration information may be used to indicate the start slot (e.g., start slot number) instead of the start subframe. For example, gapOffset may be used as yₛₗₒₜ. In this case, Equation 2 below may be used. In Equation 2, ‘mod’ may mean a modulo operation.

z=(yₛₗₒₜ mod 2^{μ}) [Equation 2]

yₛₗₒₜ may be information for calculating the start slot number of the measurement gap. The base station may deliver yₛₗₒₜ to the terminal. z may mean the start slot number of the measurement gap. yₛₗₒₜ may be set to one of 0 to 2^{μ}−1. Alternatively, yₛₗₒₜ may be set to a value greater than 2^{μ}−1. Numbers of slots may be consecutively configured in consecutive r subframes. r may be a natural number of 2 or greater. In this case, the start slot number z of the measurement gap may be determined based on Equation 3 below. The base station may inform the terminal of r. For example, r may be included in the measurement gap configuration information.

$$z = ( {y}_{slot} mod r \times {2}^{μ} ) \qquad [ Equation 3 ]$$

The terminal may receive the measurement gap configuration information from the base station, and identify the start slot number z of the measurement gap by apply gapOffset (i.e., yₛₗₒₜ) included in the measurement gap configuration information to Equation 2, or applying gapOffset (i.e., yₛₗₒₜ) and r included in the measurement gap configuration information to Equation 3. The terminal may perform a measurement operation (e.g., SSB measurement operation) from the identified start slot of the measurement gap.

In addition, the base station may transmit information indicating a configuration unit (e.g., subframe or slot) of the measurement gap to the terminal. The information indicating a measurement gap configuration unit may be included in the measurement gap configuration information (e.g., MeasConfig or MeasGapConfig). The terminal may identify the measurement gap configuration unit based on the information received from the base station, and interpret the information element(s) included in the configuration information (e.g., measurement configuration information) of the measurement gap based on the configuration unit.

### [Measurement Gap Length Configuration Method 1]

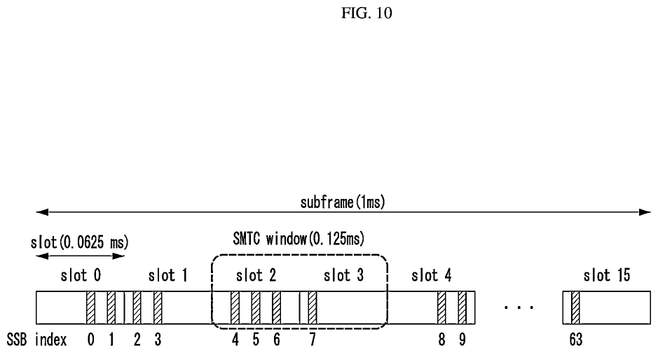

FIG. 10 is a conceptual diagram illustrating a first exemplary embodiment of a slot-based measurement gap.

Referring to FIG. 10, the SCS may be 240 kHz, and an SMTC window including specific SSBs (e.g., SSB #4 to SSB #7) may be configured. In this case, the length of the measurement gap shown in FIG. 10 may be shorter than the length of the conventional measurement gap. The length of the measurement gap may be determined based on Equation 4 below.

$$L = ( {t}_{RF} \times 2 + {t}_{slot} \times n ) \qquad [ Equation 4 ]$$

L may mean the length of the measurement gap, t_{RF} may mean the RF retuning time, tₛₗₒₜ may mean a time (e.g., length) of one slot, and n may be the number of slots determining the length of the measurement gap. tₛₗₒₜ may be determined based on the SCS. n may be an integer.

The base station may deliver t_{RF} and n to the terminal using RRC signaling. t_{RF} and n may be included in the measurement gap configuration information. The terminal may obtain t_{RF} and n from the base station, and may identify tₛₗₒₜ based on the SCS. The terminal may calculate the length L of the measurement gap by applying t_{RF}, n, and tₛₗₒₜ to Equation 4.

### [Measurement Gap Length Configuration Method 2]

Candidate values of mgl defined in Table 4 may further include values (e.g., 0.25 ms, 0.5 ms, etc.) smaller than 1 ms. For example, mgl may be set to one of 0.25 ms, 0.5 ms, 1 ms, 1.5 ms, 2 ms, 3 ms, 3.5 ms, 4 ms, 5 ms, 5.5 ms, 6 ms, 10 ms, or 20 ms. When necessary, the number of bits to represent mgl may be increased

### [Measurement Gap Configuration Method Considering Time Offset]

Communication in non-terrestrial networks may involve a propagation delay of hundreds of milliseconds or more. Therefore, the terminal may receive the measurement gap configuration information from the base station (e.g., terrestrial base station), and apply (e.g., configure) the measurement gap according to the configuration information after a time offset from a time when the measurement gap configuration information is received. The time offset may start from a subframe in which the measurement gap configuration information is received or a subframe after the subframe in which the measurement gap configuration information is received. The time offset may be expressed as the number of subframes, the number of slots, or an absolute time unit (e.g., ms). The base station may deliver the time offset to the terminal using RRC signaling. The time offset may be included in the measurement gap configuration information. The terminal may receive the time offset from the base station, and may apply (e.g., configure) the measurement gap according to the configuration information after the time offset from a time when the measurement gap configuration information is received.

For example, when the measurement gap is applied after 3 ms from a time when the measurement gap configuration information is received according to the configuration of the measurement gap, and the periodicity of the measurement gap is 40 ms, if the time offset is set to 10 ms, the terminal may apply the measurement gap after 43 ms from the time when the measurement gap configuration information is received. That is, the measurement gap may not be applied after 3 ms from the time when the measurement gap configuration information is received. The time offset may be interpreted as a minimum time between the time when the measurement gap configuration information is received and the actual application of the measurement gap according to the corresponding configuration information.

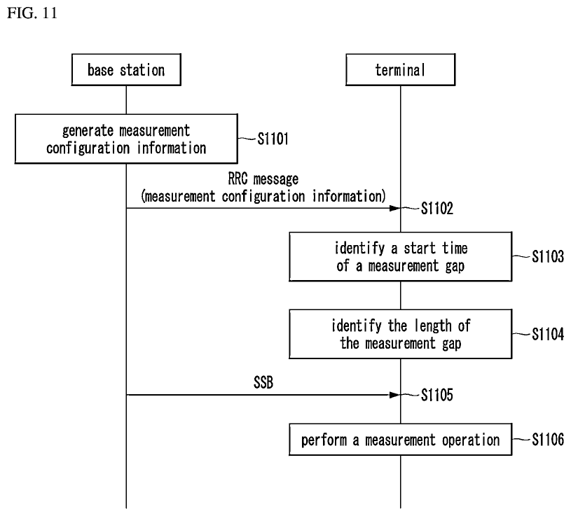

FIG. 11 is a sequence chart illustrating a first exemplary embodiment of a measurement operation in a communication system.

Referring to FIG. 11, a communication system may support multi-connectivity and may include a terminal and a base station. The terminal may be a terrestrial terminal or a non-terrestrial terminal. The base station may be a terrestrial base station or a non-terrestrial base station. The base station may generate measurement configuration information (MeasConfig) (S1101). The measurement configuration information may include measurement gap configuration information (MeasGapConfig). The measurement configuration information may be classified into terrestrial measurement configuration information and non-terrestrial measurement configuration information. The terrestrial measurement configuration information and the non-terrestrial measurement configuration information may be configured independently. The terrestrial measurement configuration information may be used in a terrestrial network, and the non-terrestrial measurement configuration information may be used in a non-terrestrial network. The measurement gap configuration information may be classified into terrestrial measurement gap configuration information and non-terrestrial measurement gap configuration information. The terrestrial measurement gap configuration information and the non-terrestrial measurement gap configuration information may be configured independently. The terrestrial measurement gap configuration information may be used in a terrestrial network, and the non-terrestrial measurement gap configuration information may be used in a non-terrestrial network.

Alternatively, the measurement configuration information may include information indicating a network to which the corresponding measurement configuration information is applied. The above information may indicate whether the measurement configuration information is applied to a terrestrial network and/or a non-terrestrial network. The measurement gap configuration information may include information indicating a network to which the corresponding measurement gap configuration information is applied. The above information may indicate whether the measurement gap configuration information is applied to a terrestrial network and/or a non-terrestrial network. Alternatively, the measurement configuration information and the measurement gap configuration information may be commonly configured to be applied to both a terrestrial network and a non-terrestrial network.

The measurement gap configuration may include one or more information elements defined in Table 6 below. The information element(s) defined in Table 6 may be included in the measurement configuration information instead of the measurement gap configuration information.

TABLE 6

| | Description |
|---|---|
| mgl | Measurement gap length (mgl) may refer to a time period of the |
| | measurement gap. mgl may be set to one value among 0.25 ms, |
| | 0.5 ms, 1 ms, 1.5 ms, 2 ms, 3 ms, 3.5 ms, 4 ms, 5 ms, 5.5 ms, |
| | 6 ms, 10 ms, or 20 ms. |
| mgrp | Measurement gap repetition periodicity (mgrp) may refer to a |
| | periodicity of the measurement gap. mgrp may be set to 20 ms, |
| | 40 ms, 80 ms, or 160 ms. |
| RF retuning | Radio frequency (RF) retuning time may refer to a time period for RF |
| time (e.g., | retuning of the terminal. The RF retuning time may be 0.5 ms in a |
| mgta) | frequency range 1 (FR1) including sub-6GH frequency bands. The |
| | RF retuning time may be 0.25 ms in an FR2 including 24-100 GHz |
| | frequency bands |
| gapOffset | gapOffset may refer to an offset of the measurement gap (e.g., |
| | measurement gap pattern). gapOffset may indicate a start subframe |
| | of the measurement gap within a period of the measurement gap. |
| | gapOffset may be set to one value among 0 to mgrp-1. mgrp-1 may |
| | be 159 ms. |
| γₛₗₒₜ | γₛₗₒₜ may indicate a start slot of the measurement gap. γₛₗₒₜ may be |
| | set to one of 0 to 2^{μ} − 1. Alternatively, γₛₗₒₜ may be set to a value |
| | greater than 2^{μ} − 1. |
| r | r may indicate the number of subframes for which slot numbers are |
| | configured consecutively. That is, the numbers of slots are |
| | consecutively configured in consecutive r subframes. |
| n | n may indicate the number of slots determining the length of the |
| | measurement gap. n may be a value applied to Equation 4. |
| time offset | Time offset may be used to indicate a time when the measurement |
| | gap according to the measurement configuration information (e.g., |
| | measurement gap configuration information) is applied in the non- |
| | terrestrial network. Time offset may be expressed as the number of |
| | subframes, the number of slots, or an absolute time (e.g., ms). |
| appNet | appNet may indicate a network (e.g., terrestrial network and/or non- |
| | terrestrial network) to which the measurement configuration |
| | information (e.g., measurement gap configuration information) |
| | is applied. |

When the measurement gap start time configuration method 1 is used, yₛₗₒₜ may be included in the measurement gap configuration information. When the measurement gap start time configuration method 2 is used, gapOffset may be interpreted as yₛₗₒₜ, and r may be included in the measurement gap configuration information. When the measurement gap length configuration method 1 is used, n may be included in the measurement gap configuration information. When the measurement gap length configuration method 2 is used, mgl may be set to a value smaller than 1 ms. In the non-terrestrial network, the measurement gap configuration information may include the time offset.

The base station may transmit an RRC message including the measurement configuration information (e.g., measurement gap configuration information) to the terminal (S1102). The terminal may receive the RRC message from the base station and identify the measurement configuration information (e.g., measurement gap configuration information) included in the RRC message. The terminal may identify the start time of the measurement gap based on the measurement gap configuration information (S1103). When the measurement gap start time configuration method 1 is used, the terminal may identify the start subframe of the measurement gap based on gapOffset, and identify the start slot within the start subframe based on yₛₗₒₜ. Alternatively, the terminal may identify the start slot of the measurement gap based on yₛₗₒₜ without considering gapOffset. The identified start slot may be a start time of the measurement gap. When the measurement gap start time configuration method 2 is used, the terminal may interpret gapOffset as yₛₗₒₜ, and identify the start time z of the measurement gap by applying yₛₗₒₜ to Equation 2 or applying yₛₗₒₜ and r to Equation 3.

The terminal may identify the length of the measurement gap based on the measurement gap configuration information (S1104). Step S1104 may be performed before or after step S1103. Alternatively, steps S1104 and S1103 may be performed simultaneously. When the measurement gap length configuration method 1 is used, the terminal may determine the length L of the measurement gap by applying t_{RF}, n, and tₛₗₒₜ to Equation 4. When the measurement gap length configuration method 2 is used, the terminal may identify the length of the measurement gap based on mgl. In the non-terrestrial network, the terminal may identify the time when the measurement gap is configured based on the time offset.

Meanwhile, the base station may periodically transmit SSB(s) (S1105). The base station may identify the measurement gap according to the measurement configuration information (e.g., measurement gap configuration information) based on the above-described methods. The SSB(s) may be transmitted within the measurement gap according to the measurement configuration information. The terminal may perform a measurement operation on the SSB(s) within the measurement gap (S1106). Based on a result of the measurement operation, the terminal may perform a next operation (e.g., a handover operation to a neighboring cell, an operation to connect to another network, and/or an access operation to another frequency band).

In the present disclosure, the SSB(s) may be SSB(s) that the terminal receives within the measurement gap. For example, the SSB(s) may be SSB(s) transmitted by or in neighboring cell(s), neighboring base station(s), other network(s), other system(s), and/or different frequency band(s). The configuration operation of the measurement gap and the measurement operation with the measurement gap may be performed based on a combination of the methods described above. The above methods may be applied to a communication system supporting a handover operation to a neighboring cell, a connection operation to another network, and/or an access operation to another frequency band.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a terminal, comprising:
receiving measurement configuration information from a base station;
identifying a start time of a measurement gap based on the measurement configuration information;
identifying a length of the measurement gap based on the measurement configuration information; and
performing a measurement operation in the measurement gap,
wherein the measurement gap is configured in units of slots, the start time of the measurement gap is a start slot, and the measurement gap includes one or more slots.

2. The method according to claim 1, wherein the identifying of the start time of the measurement gap comprises: identifying the start slot based on a first information element indicating the start slot of the measurement gap, the first information element being included in the measurement configuration information.

3. The method according to claim 1, wherein the identifying of the start time of the measurement gap comprises:
identifying a start subframe based on a second information element indicating the start subframe of the measurement gap, the second information element being included in the measurement configuration information; and
identifying the start slot within the start subframe based on a first information element indicating the start slot of the measurement gap, the first information element being included in the measurement configuration information.

4. The method according to claim 1, wherein the start slot of the measurement gap is identified based on an equation z=(yₛₗₒₜ mod 2^{μ}), wherein z indicates the start slot, yₛₗₒₜ is a value determined based on a second information element indicating a start subframe of the measurement gap, and μ indicates a numerology, the second information element being included in the measurement configuration information.

5. The method according to claim 1, wherein the start slot of the measurement gap is identified based on an equation z=(yₛₗₒₜ mod r×2^{μ}), wherein z indicates the start slot, yₛₗₒₜ is a value determined based on a second information element indicating a start subframe of the measurement gap, r is a value determined based on a third information element indicating a number of subframes for which slot numbers are consecutively configured, and μ indicates a numerology, the second and third information elements being included in the measurement configuration information.

6. The method according to claim 1, wherein the length of the measurement gap is identified based on an equation L=(t_{RF}×2+tₛₗₒₜ×n), wherein L indicates the length of the measurement gap, t_{RF} is a value determined based on a fourth information element indicating a radio frequency (RF) retuning time, tₛₗₒₜ indicates a time of one slot, and n is a value determined based on a fifth information element indicating a number of slots determining the length of the measurement gap, the fourth and fifth information elements being included in the measurement configuration information.

7. The method according to claim 1, wherein the measurement configuration information includes a sixth information element indicating a time when the measurement gap is configured in a non-terrestrial network, the sixth information element is a time offset, and the measurement gap is configured after the time offset from a time when the measurement configuration information is received.

8. The method according to claim 1, wherein the measurement configuration information includes a seventh information element indicating a network to which the measurement configuration information is applied, and the seventh information element indicates that the measurement configuration information is applied to at least one of a terrestrial network and a non-terrestrial network.

9. A method of a base station, comprising
generating measurement configuration information for configuring a measurement gap based on slot(s);
transmitting the measurement configuration information to a terminal; and
transmitting a synchronization signal block (SSB) to the terminal in the measurement gap configured based on the measurement configuration information,
wherein the measurement gap includes one or more slots, and the measurement configuration information includes a first information element indicating a start slot of the measurement gap.

10. The method according to claim 9, wherein the measurement configuration information further includes a second information element indicating a start subframe of the measurement gap, and the start slot is located within the start subframe indicated by the second information element.

11. The method according to claim 9, wherein the length of the measurement gap is identified based on an equation L=(t_{RF}×2+tₛₗₒₜ×n), wherein L indicates the length of the measurement gap, t_{RF} is a value determined based on a third information element indicating a radio frequency (RF) retuning time, tₛₗₒₜ indicates a time of one slot, and n is a value determined based on a fourth information element indicating a number of slots determining the length of the measurement gap, the third and fourth information elements being included in the measurement configuration information.

12. The method according to claim 9, wherein the measurement configuration information includes a fifth information element indicating a time when the measurement gap is configured in a non-terrestrial network, the fifth information element is a time offset, and the measurement gap is configured after the time offset from a time when the measurement configuration information is transmitted.

13. The method according to claim 9, wherein the measurement configuration information includes a sixth information element indicating a network to which the measurement configuration information is applied, and the sixth information element indicates that the measurement configuration information is applied to at least one of a terrestrial network and a non-terrestrial network.

14. A terminal comprising a processor, wherein the processor is executed to cause the terminal to:
receive measurement configuration information from a base station;
identify a start time of a measurement gap based on the measurement configuration information;
identify a length of the measurement gap based on the measurement configuration information; and
perform a measurement operation in the measurement gap,
wherein the measurement gap is configured in units of slots, the start time of the measurement gap is a start slot, and the measurement gap includes one or more slots.

15. The terminal according to claim 14, wherein in the identifying of the start time of the measurement gap, the processor is executed to cause the terminal to: identify the start slot based on a first information element indicating the start slot of the measurement gap, the first information element being included in the measurement configuration information.

16. The terminal according to claim 14, wherein in the identifying of the start time of the measurement gap, the processor is executed to cause the terminal to:
identify a start subframe based on a second information element indicating the start subframe of the measurement gap, the second information element being included in the measurement configuration information; and
identify the start slot in the start subframe based on a first information element indicating the start slot of the measurement gap, the first information element being included in the measurement configuration information.

17. The terminal according to claim 14, wherein the start slot of the measurement gap is identified based on an equation z=(yₛₗₒₜ mod 2^{μ}), wherein z indicates the start slot, yₛₗₒₜ is a value determined based on a second information element indicating a start subframe of the measurement gap, and μ indicates a numerology, the second information element being included in the measurement configuration information.

18. The terminal according to claim 14, wherein the start slot of the measurement gap is identified based on an equation z=(yₛₗₒₜ mod r×2^{μ}), wherein z indicates the start slot, yₛₗₒₜ is a value determined based on a second information element indicating a start subframe of the measurement gap, r is a value determined based on a third information element indicating a number of subframes for which slot numbers are consecutively configured, and μ indicates a numerology, the second and third information elements being included in the measurement configuration information.

19. The terminal according to claim 14, wherein the length of the measurement gap is identified based on an equation L=(t_{RF}×2+tₛₗₒₜ×n), wherein L indicates the length of the measurement gap, t_{RF} is a value determined based on a fourth information element indicating a radio frequency (RF) retuning time, tₛₗₒₜ indicates a time of one slot, and n is a value determined based on a fifth information element indicating a number of slots determining the length of the measurement gap, the fourth and fifth information elements being included in the measurement configuration information.

20. The terminal according to claim 14, wherein the measurement configuration information includes at least one of a sixth information element indicating a time when the measurement gap is configured in a non-terrestrial network or a seventh information element indicating a network to which the measurement configuration information is applied, the sixth information element is a time offset, the measurement gap is configured after the time offset from a time when the measurement configuration information is received, and the seventh information element indicates that the measurement configuration information is applied to at least one of a terrestrial network and a non-terrestrial network.
